(19) United States
(12) Patent Application Publication
(10) Pub. No.: US 2013/0290840 A1
(43) Pub. Date: Oct. 31, 2013

(54) Document Management Apparatus for Managing a Document Image Including Handwritten Comment Areas

(71) Applicant: KYOCERA DOCUMENT SOLUTIONS INC., Osaka (JP)

(72) Inventors: Ryosuke Ogishi, Osaka (JP); Masaaki Aiba, Osaka (JP); Takashi Murakami, Osaka (JP); Yosuke Kashimoto, Osaka (JP)

(73) Assignee: KYOCERA Document Solutions Inc., Osaka (JP)

(21) Appl. No.: 13/872,815

(22) Filed: Apr. 29, 2013

(30) Foreign Application Priority Data
Apr. 27, 2012 (JP) 2012-102163

(51) Int. Cl. G06F 17/24; G06K 9/00

(52) U.S. Cl. CPC G06F 17/24; G06K 9/00154
USPC 715/268

(57) ABSTRACT

A document management apparatus includes: a handwriting extracting unit configured to extract a handwritten comment area within a document image; a data management unit configured to store, in a storage device, document image data indicative of the document image and, in association therewith, handwritten data that defines content of the handwritten comment area within the document image; and a handwriting operation unit configured to update, upon receipt of an operation for editing content of the handwritten comment area, the handwritten data in accordance with the operation for editing.

### REFERENCE TO RELATED APPLICATIONS

This application is based upon and claims the benefit of priority from the corresponding Japanese Patent Application No. 2012-102163, filed in the Japan Patent Office on Apr. 27, 2012, the entire contents of which are incorporated herein by reference.

### BACKGROUND

1. Field

The present invention generally relates to document management apparatuses for managing document images including handwritten comment areas.

2. Description of the Related Art

In general, handwritten comments are written on distributed documents (e.g., printed paper). Typical document management apparatuses read the image of such a document with the handwritten comments, extract the comment portions from the image, and manage the comments. Other typical document management apparatuses extract handwritten portions within a document image.

However, in these typical document management apparatuses, handwritten comment areas can only be read or deleted, and the handwritten content is not effectively utilized after the document image has been read.

### SUMMARY

A document management apparatus according to the present disclosure includes: a handwriting extracting unit, a data management unit, and a handwriting operation unit. The handwriting extracting unit is configured to extract a handwritten comment area within a document image. The data management unit is configured to store, in a storage device, document image data indicative of the document image and, in association therewith, handwritten data that defines content of the handwritten comment area within the document image. The handwriting operation unit is configured to update, upon receipt of an operation for editing content of the handwritten comment area, the handwritten data in accordance with the operation for editing.

A non-transitory computer-readable recording medium according to the present disclosure includes a document management program executable by a computer of a document management apparatus. The document management program includes first program code to third program code. The first program code causes the computer to extract a handwritten comment area within a document image. The second program code causes the computer to store, in a storage device, document image data indicative of the document image and, in association therewith, handwritten data that defines content of the handwritten comment area within the document image. The third program code causes the computer to update, upon receipt of an operation for editing content of the handwritten comment area, the handwritten data in accordance with the operation for editing.

A method of document management according to the present disclosure includes: (i) extracting, using a handwriting extracting unit, a handwritten comment area within a document image, (ii) storing, using a data management unit, in a storage device, document image data indicative of the document image and, in association therewith, handwritten data that defines content of the handwritten comment area within the document image, and (iii) updating, using a handwriting operation unit, upon receipt of an operation for editing content of the handwritten comment area, the handwritten data in accordance with the operation for editing.

Additional features and advantages are described herein, and will be apparent from the following Detailed Description and the figures.

### BRIEF DESCRIPTION OF THE DRAWINGS

In the accompanying drawings:

FIG. 1 illustrates a configuration of an image forming apparatus that is an example of a document management apparatus, according to an embodiment of the present disclosure;

FIG. 2 illustrates a processing flow that may be performed by the apparatus illustrated in FIG. 1, at a time when document image data is stored;

FIG. 3 illustrates an example data structure maintained in the apparatus illustrated in FIG. 1, at a time when document image data is stored;

FIG. 4 illustrates state transitions that may be performed by the apparatus illustrated in FIG. 1 when utilizing handwritten data in the apparatus after the data has been stored;

FIG. 5 illustrates an example document list in a document box displayed by the apparatus illustrated in FIG. 1;

FIG. 6 illustrates an example document attribute information screen displayed by the apparatus illustrated in FIG. 1;

FIG. 7 illustrates an example comment list screen displayed by the apparatus illustrated in FIG. 1;

FIG. 8 illustrates an example comment detail screen displayed by the apparatus illustrated in FIG. 1; and

FIG. 9 illustrates an example comment detail screen after addition performed in the comment detail screen illustrated in FIG. 8.

### DETAILED DESCRIPTION

Hereinafter, embodiments of the present disclosure are described with reference to the attached drawings.

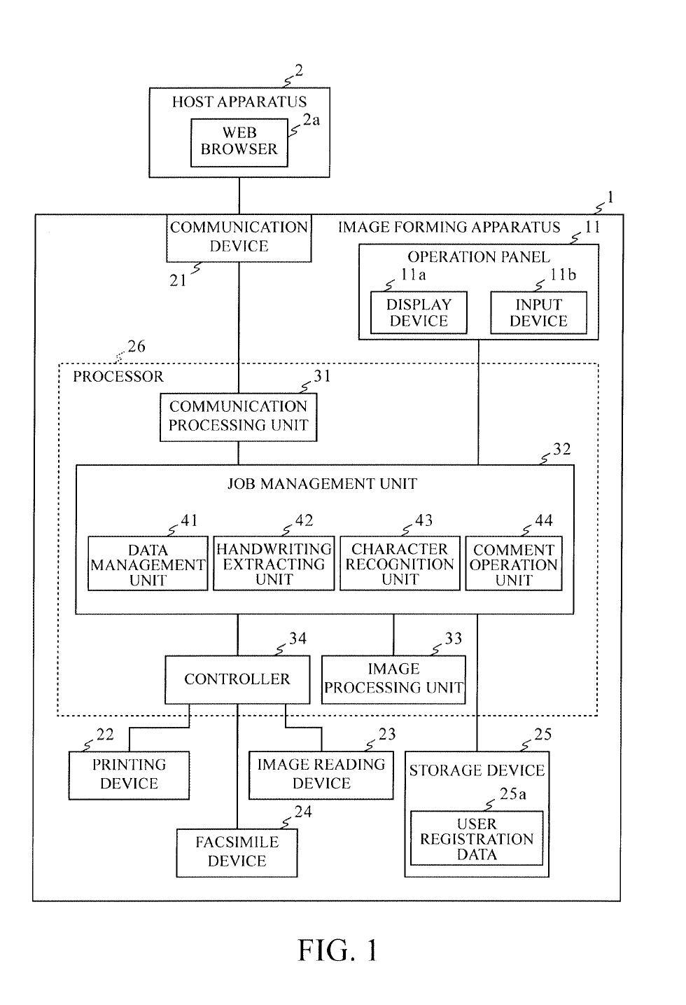

FIG. 1 is a diagram illustrating a configuration of an image forming apparatus that is an example of a document management apparatus according to an embodiment of the present disclosure.

In the present embodiment, an image forming apparatus 1 is a multifunction apparatus that includes a printing function, an image reading function, and a facsimile function. A host apparatus 2 is connected via a network to the image forming apparatus 1. The host apparatus 2 includes a display device and an input device (neither of which are illustrated in FIG. 1). The host apparatus 2 can read document images etc. stored in the image forming apparatus 1 using an internal Web browser 2a.

The image forming apparatus 1 includes an operation panel 11, a communication device 21, a printing device 22, an image reading device 23, a facsimile device 24, a storage device 25, and a processor 26.

The operation panel 11 includes a display device 11a, such as an LCD display, and an input device 11b, such as a touch panel. The operation panel 11 displays an operation screen for a user and detects user operations.

The communication device 21 is communicatively connected to the host apparatus 2 via, for example, a network. The communication device 21 is a device that performs data communication using specific communication protocols.

The printing device 22 is an internal device that prints document images on print sheets using, for example, an electrophotographic method.

The image reading device 23 is an internal device that optically reads the document images of original documents and generates the image data that corresponds to the document images.

The facsimile device 24 is an internal device that executes (i) a reception function of receiving a facsimile signal and converting the signal into image data and (ii) a transmission function of converting image data into a facsimile signal and transmitting the facsimile signal.

The storage device 25 stores data, programs, etc. In the storage device 25, a document box is provided (not shown), and document image data generated by the image reading device 23 are stored in the document box. The storage device 25 may be a non-volatile memory, such as a hard disk drive or a flash memory, for example.

The processor 26 is a computer including a central processing unit (CPU), a read-only memory (ROM), a random access memory (RAM), etc. (not illustrated). The processor 26 loads programs stored in the ROM or the storage device 25 into the RAM. The processor 26 executes the programs using the CPU, thereby functioning as various processing units.

After the image forming apparatus 1 has been activated, various programs are appropriately executed by the processor 26. In the present embodiment, the processor 26 includes processing units, such as a communication processing unit 31, a job management unit 32, an image processing unit 33, and a controller 34.

The communication processing unit 31, through control of the communication device 21, performs data communication with the host apparatus 2 using specific protocols. The communication processing unit 31 includes a Web server. The communication processing unit 31 communicates with the Web browser 2a of the host apparatus 2 using the Hyper Text Transfer Protocol (HTTP).

The job management unit 32 receives requests based on user operations performed on the operation panel 11, requests received from the host apparatus 2, etc., and causes processing to be performed in response to the requests. The job management unit 32, upon receipt of a request, performs login processing for a user on the basis of a user ID and a password, with reference to user registration data 25a stored in the storage device 25. During the login processing, a user is identified on the basis of the user ID and, as required, user authentication is performed on the basis of the user ID and the password during processing. The user registration data 25a includes user attribute information, such as a password, access rights, and a user group to which the user belongs, etc. The user attribute information is associated with a user ID.

The image processing unit 33 performs image processing on document image data in the storage device 25, and creates print data (for example, print image binary data for each color).

The controller 34 monitors and controls the internal devices, such as the printing device 22, the image reading device 23, and the facsimile device 24. For example, the controller 34 may control the printing device 22 such that the printing device 22 prints an image-based on print data on a print sheet, and may control the facsimile device 24 such that the facsimile device 24 generates facsimile image data corresponding to the document image data described above and transmits an image based on the facsimile image data.

The job management unit 32 includes a data management unit 41, a handwriting extracting unit 42, a character recognition unit 43, and a comment operation unit 44.

The data management unit 41, stores the document image data indicative of a document image in the document box in the storage device 25, and manages the document image data in the document box. The data management unit 41 stores the document image data indicative of a document image in the document box in the storage device 25 in association with handwritten data that defines the content of handwritten comment areas within the document image.

Note the document image data can include the image data indicative of the document image of a document including a single page or a plurality of pages. The data management unit 41 stores, in the storage device 25, handwriting attribute data indicating the attributes of handwritten comment areas in association with the document image data and/or handwritten data. The handwriting attribute data includes identification information (for example, page numbers) indicative of pages including handwritten comment areas and position information indicating positions within a page with the handwritten comment areas.

The handwriting extracting unit 42 extracts handwritten comment areas in the document image by processing the document image data using, for example, a processing technique disclosed in Japanese Unexamined Patent Application Publication No. 2005-175565, and outputs image data of the handwritten comment areas as handwritten data.

The character recognition unit 43 generates text data corresponding to the handwritten characters within the handwritten comment areas from the image data using a character recognition technique, and outputs the text data as handwritten data.

The comment operation unit 44, upon receipt of an operation for editing content of a handwritten comment area that is displayed on the display device 11a of the operation panel 11 or displayed on the display device of the host apparatus 2 by the Web browser 2a, updates the handwritten data in response to the editing. Note, “editing” refers to addition to or correction of the content of a handwritten comment area.

If handwritten data is text data, the text data is updated in response to the editing. If the handwritten data is image data, text data corresponding to the editing is stored in association with the image data.

The comment operation unit 44 may display the list of handwritten comment areas on the relevant display device and display the content of a handwritten comment area selected from the list on the relevant display device. The list of handwritten comment areas may list, page by page, the content of handwritten comment areas included in a page.

When displaying the content of handwritten comment areas, the comment operation unit 44 may display, in addition to the identification information indicative of a page with the handwritten comment areas, a reduced image of the page and an image illustrating the positions of the handwritten comment areas within the reduced image, on the basis of position information in the hand writing attribute data.

The comment operation unit 44, in response to a user request, may transmit the updated handwritten data to a specific address using the communication processing unit 31.

The operation of the image forming apparatus described above will now be described.

### (1) Storing Document Image Data

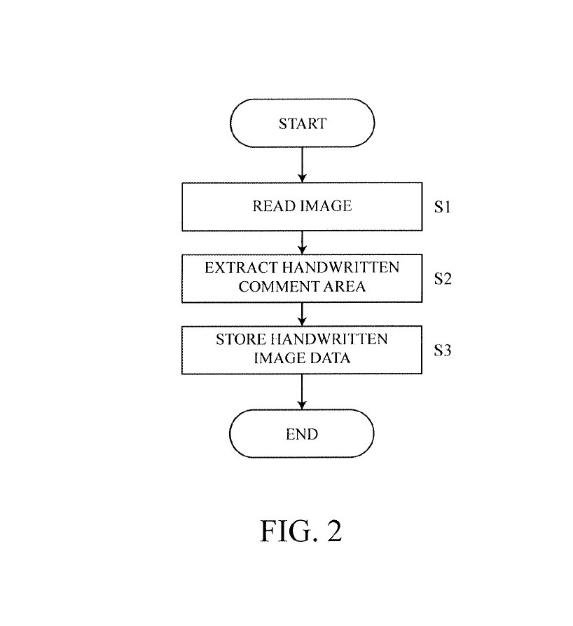

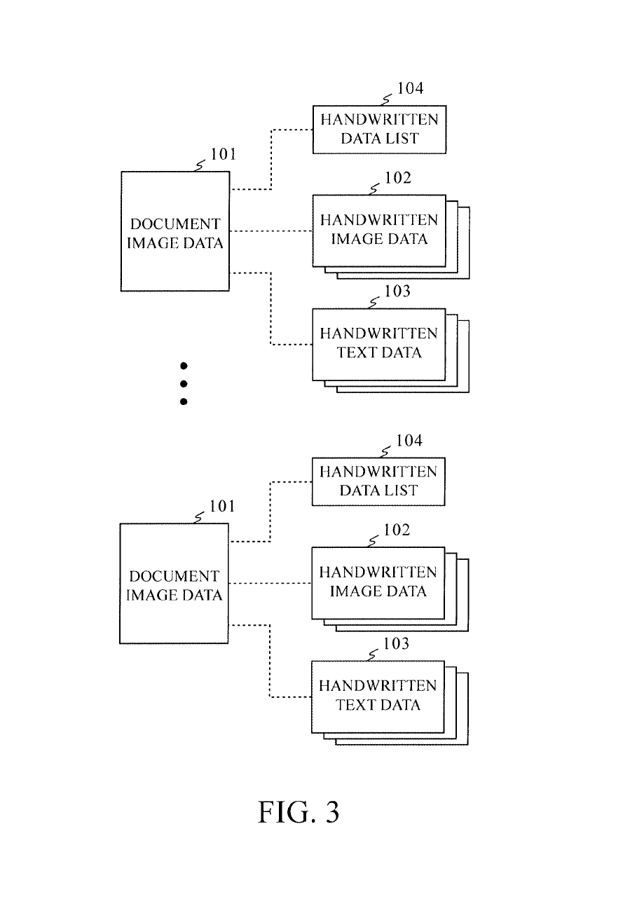

FIG. 2 illustrates a processing flow that may be carried out by the apparatus illustrated in FIG. 1 at a time when document image data is stored. FIG. 3 illustrates an example data structure maintained in the apparatus illustrated in FIG. 1 at a time when document image data is stored.

Referring to FIG. 2, if a specific user operation is detected by the input device 11b, the job management unit causes a controller to read a document image. Using the image reading device, controlled by the controller, a document image of a document composed of one or a plurality of pages is read page by page to generate image data (step S1).

The data management unit stores one or a plurality of pages of image data generated by the image reading device in the storage device as document image data. The document image data is stored in the document box in the storage device and the data management unit stores the attribute information of the document image data in association with the document image data.

The handwriting extracting unit extracts handwritten comment areas within the document image by processing the document image data, and outputs the image data of the handwritten comment areas (hereinafter, called handwritten image data) to the data management unit (step S2).

The character recognition unit extracts hand written characters from the handwritten image data, and outputs the text data of the handwritten characters (hereinafter, called hand written text data) to the data management unit.

The data management unit 41 stores the handwritten image data and the hand written text data in the storage device in association with the document image data (step S3).

At this time, as illustrated in FIG. 3, for each document, document image data 101, handwritten image data 102, handwritten text data 103, and a hand written data list 104 are stored in the storage device 25. More specifically, the data management unit generates, for each handwritten comment area, handwriting attribute data including the page number of a page with the handwritten comment area, information about a position in the page with the handwritten comment area, an identifier (for example, a file name) of the handwritten image data 102, an identifier (for example, a file name) of the handwritten text data 103, and stores, in the storage device 25, a hand written data list 104 including the hand writing attribute data for all the handwritten comment areas in a document in association with the document image data 101.

### (2) Utilizing Handwritten Data

A user can read documents stored in the document box as described above through operation of the operation panel or the host apparatus.

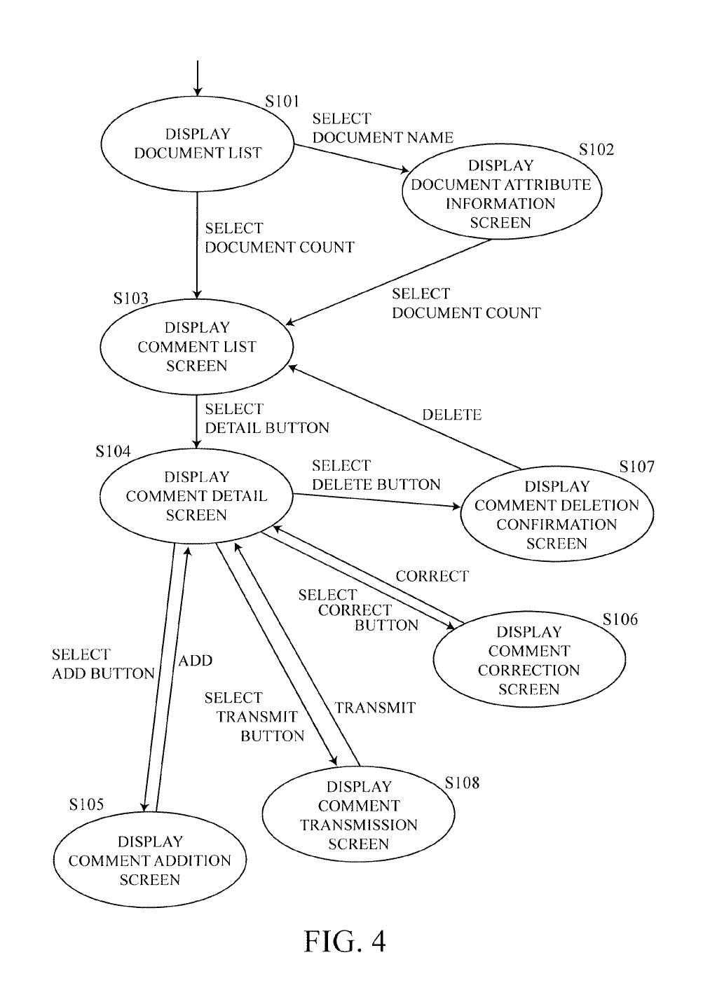

FIG. 4 illustrates state transitions that may be performed by the apparatus illustrated in FIG. 1 when utilizing handwritten data in the apparatus illustrated in FIG. 1, after the data has been stored.

Upon receipt of a request for reading the document box from the operation panel or the host apparatus through a specific user operation, the data management unit displays a document list stored in the document box on the display device of the operation panel or the display device of the host apparatus (state S101).

Various requests from the host apparatus are transmitted from the Web browser to the image forming apparatus 1 using, for example, the HTTP protocol. In the image forming apparatus, the Web server of the communication processing unit 31 receives the request, the job management unit creates screen data (e.g., Hypertext Markup Language (HTML) data) corresponding to the request, and the Web server transmits the screen data to the Web browser. The Web browser, upon receipt of the screen data, displays a screen on the display device of the host apparatus.

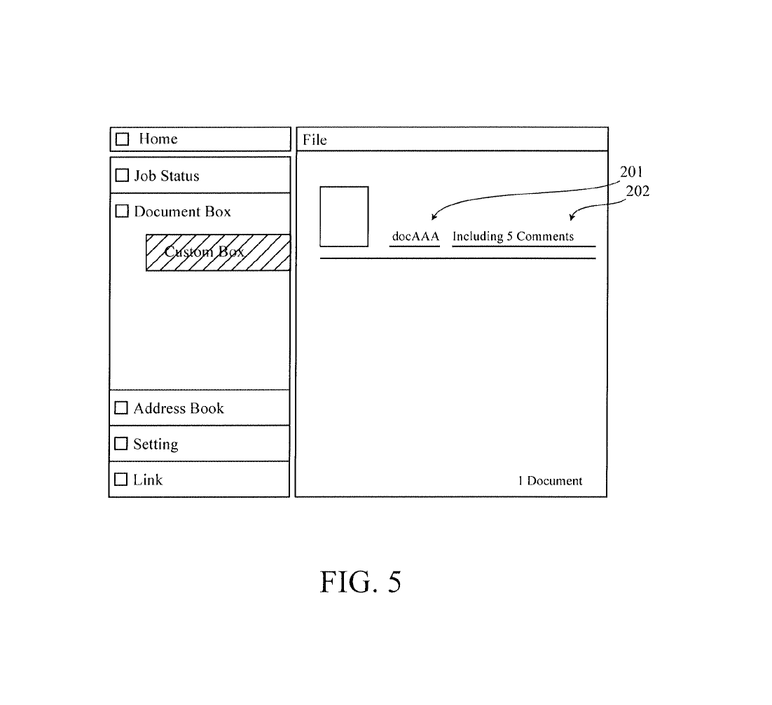

FIG. 5 illustrates an example document list in the document box displayed by the apparatus illustrated in FIG. 1. Referring to FIG. 5, for each document, the document list includes a document name 201 and a comment count 202. The document name 201 functions as a link to a document attribute information screen. The comment count 202 functions as a link to a comment list screen.

A user selects a document from the document list displayed on the display device and selects the document name 201 or the comment count 202 of the selected document through operation of the input device of the operation panel or through operation of the input device of the host apparatus 2.

If the document name 201 in the document list is selected, the data management unit reads the attribute information of the document image data 101 corresponding to the selected document name 201, and displays a document attribute information screen on the relevant display device.

If the comment count 202 in the document list is selected, the comment operation unit identifies the document image data corresponding to the selected comment count 202. Further, the comment operation unit reads a handwritten data list associated with the document image data, as well as hand written image data and/or handwritten text data, and displays a comment list screen on the relevant display device.

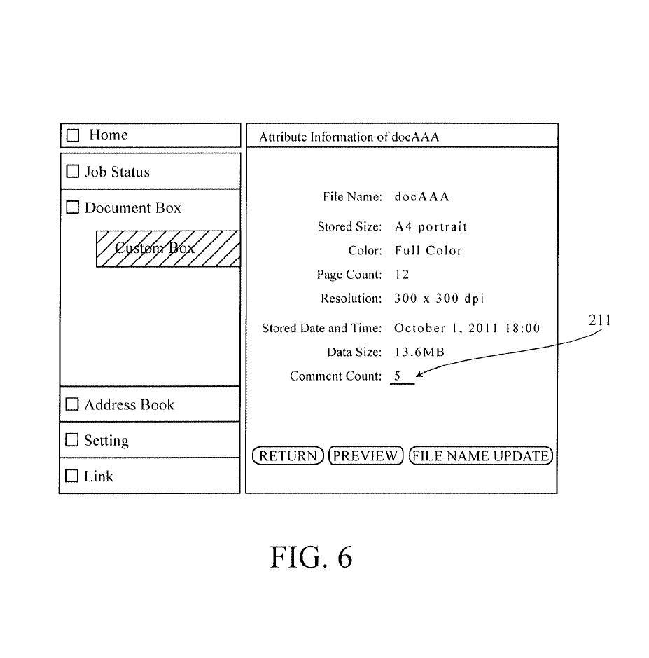

FIG. 6 illustrates an example document attribute information screen displayed by the apparatus illustrated in FIG. 1. Referring to FIG. 6, in the document attribute information screen, the attribute information of the selected document image data is displayed. The attribute information includes a file name, a stored size of a document, a color, a number of pages, a resolution, a stored date and time of a document, a data size, and a comment count 211. The comment count 211 functions as a link to a comment list screen.

In the document attribute information screen, a user, if he/she wants to display a comment list screen, selects the comment count 211 through operation of the input device of the operation panel or through operation of the input device of the host apparatus.

If the comment count 211 in the document attribute information screen is selected, the comment operation unit identifies any document image data corresponding to the comment count 211. Further, the comment operation unit reads a handwritten data list associated with the document image data, as well as hand written image data and/or handwritten text data, and displays a comment list screen on the relevant display device.

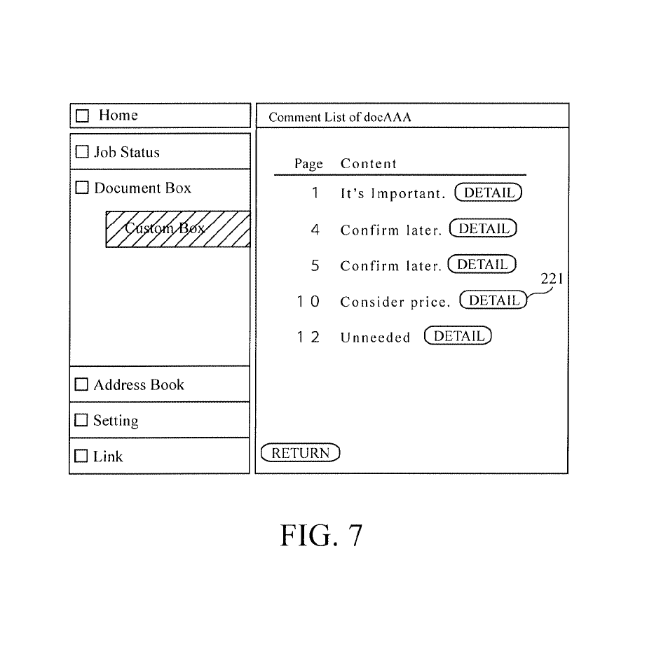

FIG. 7 illustrates an example comment list screen displayed by the apparatus illustrated in FIG. 1. Referring to FIG. 7, in the comment list screen, the list of handwritten comment areas extracted from a single document is displayed. In the list of handwritten comment areas, the page number of the extracted page, the content of the handwritten comment area, and a detail button are displayed for each of the handwritten comment areas. The detail button functions as a link to a comment detail screen. The page numbers are identified from the handwritten data list. The content of each handwritten comment area is made to be an image based on the handwritten image data or text based on the handwritten text data.

In the comment list screen, a user, if he/she wants to display a comment detail screen regarding the content (i.e., the comment) of a handwritten comment area, selects a detail button 221 through operation of the input device of the operation panel or through operation of the input device of the host apparatus.

If the detail button 221 is selected, the comment operation unit identifies handwritten image data and/or handwritten text data corresponding to the detail button 221, identifies the page number of a page with the handwritten comment area and the position of the area within the page from the handwritten data list, and displays a comment detail screen on the relevant display device.

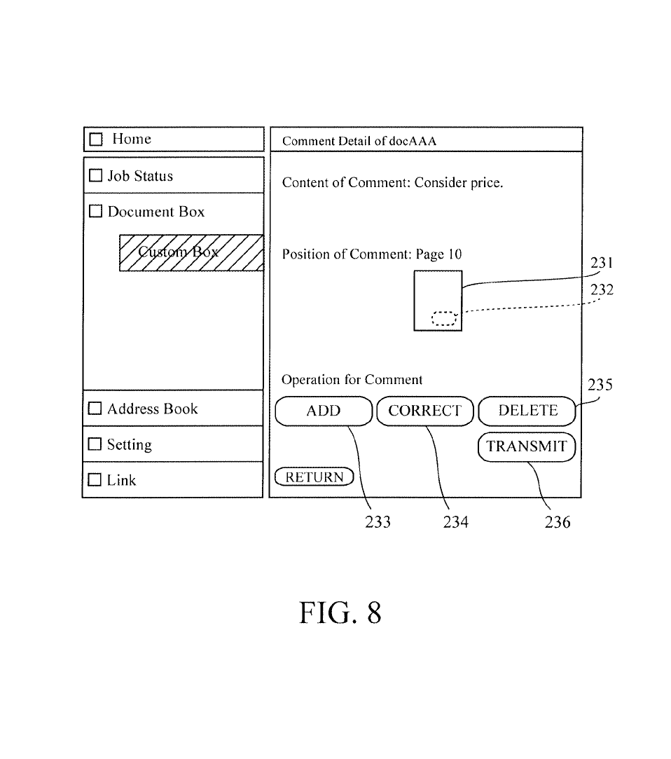

FIG. 8 illustrates an example comment detail screen displayed by the apparatus illustrated in FIG. 1. Referring to FIG. 8, in the comment detail screen, the content (i.e., the comment) of the handwritten comment area is displayed as an image based on the handwritten image data and/or text based on the handwritten text data. The position of the comment is indicated using a page number and a reduced image 231. In the reduced image 231, an overlapping image 232 indicating the position of the handwritten comment area within the page is displayed.

The comment operation unit 44 may extract image data including the handwritten comment area from the document image data 101, and based on this image data, create the image data indicative of the reduced image 231 overlapped by the image 232. The data management unit 41, when storing the handwritten image data and handwritten text data, may create the image data indicative of the reduced image 231 overlapped by the image 232 for each handwritten comment area from the document image data 101 and store the created image data in association with the document image data. The comment operation unit, when displaying the comment detail screen, may read the image data indicative of the reduced image 231 associated with the document image data and display the read image data within the comment detail screen.

As illustrated in FIG. 8, operation buttons for operation of the handwritten comment area are displayed in the comment detail screen. In the comment detail screen illustrated in FIG. 8, an add button 233, a correct button 234, a delete button 235, and a transmit button 236 are displayed as operational buttons for editing the handwritten comment area. The add button 233 is an operation button for adding a comment or the like to the content of the handwritten comment area. The correct button 234 is a button for correcting the content of the handwritten comment area. The delete button 235 is a button for deleting the handwritten comment area. The transmit button 236 is a button for transmitting the content of the handwritten comment area.

Using the comment detail screen, a user that wants to make addition to the content (i.e., comment) of the handwritten comment area can select the add button 233 through operation of the input device of the operation panel or the input device of the host apparatus. If the add button 233 is selected, the comment operation unit displays a comment addition screen on the relevant display device.

If a user enters text to be added in the comment addition screen, the comment operation unit 44 adds the text data of the added text to handwritten text data corresponding to the comment addition screen. The comment operation unit 44 displays a comment detail screen including the added text based on the handwritten text data after the addition.

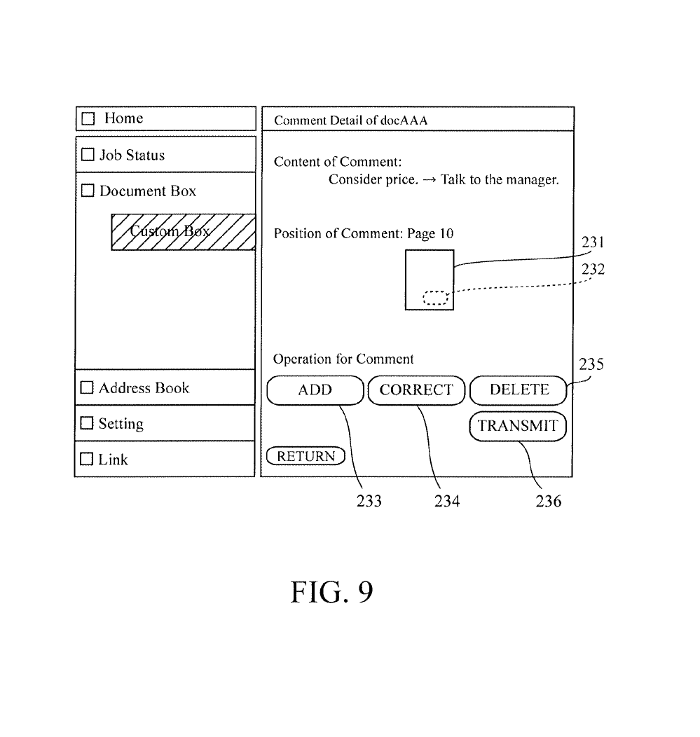

FIG. 9 illustrates an example of the comment detail screen after the addition performed in the comment detail screen illustrated in FIG. 8. In the state illustrated in FIG. 9, additional text 241 “→Talk to the manager.” is added to the comment “Consider price.”, and text “Consider price. →Talk to the manager.” is displayed.

At this time, the additional text data may be stored in association with the handwritten image data as well as being added to the handwritten text data. When the image of the handwritten comment area is displayed on the basis of the handwritten image data, text based on the additional text data associated with the handwritten image data may also be displayed.

Note that if the add button 233 is selected in the comment detail screen illustrated in FIG. 9, other additional text 241 may be added, similarly to the above.

Using the comment detail screen illustrated in FIG. 8 (or FIG. 9), a user that wants to correct the content of the handwritten comment area can select the correct button 234 through operation of the input device of the operation panel or the input device of the host apparatus. If the correct button 234 is selected, the comment operation unit displays a comment correction screen on the relevant display device.

If a user enters text in the comment correction screen, the comment operation unit replaces handwritten text data corresponding to the comment correction screen with the text data of the text, and displays a comment detail screen including the text based on the handwritten text data after the correction.

At this time, handwritten image data corresponding to the handwritten comment area may be deleted, as well as the handwritten text data being replaced with the corrected text data.

Using the comment detail screen illustrated in FIG. 8 (or FIG. 9), a user that wants to delete the content (i.e., the comment itself) of the handwritten comment area can select the delete button 235 through operation of the input device of the operation panel or the input device of the host apparatus. If the delete button 235 is selected, the comment operation unit displays a comment deletion confirmation screen on the relevant display device.

When a user performs an operation for approving deletion of the comment in the comment deletion confirmation screen, the comment operation unit deletes the handwritten image data and the handwritten text data of the handwritten comment area, deletes information about the corresponding handwritten comment area in the handwritten data list, and displays a comment list screen after the deletion.

At this time, the image of the handwritten comment area in the document image data may be deleted, as well as the handwritten image data and the handwritten text data being deleted.

Using the comment detail screen a user that wants to transmit the content (i.e., the comment itself) can select the transmit button 236 through operation of the input device of the operation panel or the input device of the host apparatus. If the transmit button 236 is selected, the comment operation unit displays a comment transmission screen on the relevant display device.

If a user selects a protocol (such as an electronic mail protocol, the File Transfer Protocol (FTP), and the Server Message Block (SMB) protocol) to be used for transmission and enters address information corresponding to the selected protocol, the comment operation unit transmits handwritten image data and/or handwritten text data corresponding to the handwritten comment area through the communication processing unit using the selected protocol. After completion of the transmission, the comment operation unit displays the comment detail screen again. As a transmission destination of the handwritten image data and/or the handwritten text data, a removable portable storage medium, such as a Universal Serial Bus (USB) memory stick connected to the image forming apparatus 1 may be made selectable.

In this manner, according to the embodiment described above, the handwriting extracting unit extracts handwritten comment areas within a document image, and the data management unit stores, in a storage device, the document image data indicative of the document image and handwritten data that defines the content of the handwritten comment areas within the document image in association with each other. The comment operation unit, upon receipt of an operation for editing content of the handwritten comment areas, updates the handwritten data (e.g., handwritten image data and/or handwritten text data) in response to the editing.

As a result, the handwritten comment areas can be edited after being extracted, thereby enabling effective utilization of the handwritten content after a document image has been read.

For example, a user may write comments in a paper document at a meeting, and after the meeting, store the document image data corresponding to the paper document in a document box using an image forming apparatus. At this time, hand written data is automatically generated and stored together with the document image data, and the paper document may be discarded. Afterwards the user, while reading the document stored in the document box, can add, correct, delete, and transmit the comment as required, as described above.

The above-described embodiment is an example of the present disclosure. The present disclosure is not limited to this, and various variations and modifications are possible within the scope and spirit of the present disclosure.

For example, although the storage device is housed in the image forming apparatus in the above-described embodiment, an external storage device may be used instead of the storage device.

In the above-described embodiment, the input device of the operation panel and the input device of the host apparatus may include a handwriting input device. When a comment is to be added, a user may input handwritten text through operation of the handwriting input device, whereby the comment operation unit may store image data including the input handwritten content in association with handwritten image data. Afterwards, the comment operation unit may display the handwritten image data and an image generated based on the image data as the content of the handwritten comment area.

In the above-described embodiment, by determining, for each user, whether or not editing content of a handwritten comment area is forbidden, the comment operation unit may forbid a specific user from editing the content of the handwritten comment area.

In this case, access right information is stored in association with a document box or document image data. The access right information may include, for example, user IDs, user group IDs, and user rights. The comment operation unit may permit (or forbid) the user to edit the content of the handwritten comment area in response to the access right information.

In the above case, a configuration may be employed in which editing content of handwritten comment areas is permitted to, for example, a user who is the owner of a document box, users and/or user groups granted access by the owner of the document box, and users having specified user rights, and is forbidden to other users. For example, when addition is forbidden, the add button 233 in a comment detail screen may be grayed out so as to be disabled.

Further, a configuration may be employed in which addition to the content of handwritten comment areas is permitted to, for example, a user who is the owner of the document image data 101 or a document box in which the document image data 101 is stored, users and/or user groups granted access by the owner, and users having specified user rights and is forbidden to other users. Correction of the content of handwritten comment areas may be permitted to only the owner, and forbidden to other users.

The present disclosure is applicable to, for example, image forming apparatuses, such as multifunction apparatuses.

It should be understood that various changes and modifications to the presently embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A document management apparatus comprising:
a handwriting extracting unit configured to extract a handwritten comment area within a document image;
a data management unit configured to store, in a storage device, document image data indicative of the document image and, in association therewith, handwritten data that defines content of the handwritten comment area within the document image; and
a handwriting operation unit configured to update, upon receipt of an operation for editing content of the handwritten comment area, the handwritten data in accordance with the operation for editing.

2. The document management apparatus according to claim 1,
wherein the document image data includes image data indicative of at least one page of the document image or a plurality of pages of the document image,
wherein the data management unit is further configured to store, in the storage device, handwriting attribute data including identification information indicative of a page with the handwritten comment area in association with the document image data or the handwritten data, and
wherein the handwriting operation unit is further configured to display, on a display device, the identification information indicative of the page with the handwritten comment area and the content of the handwritten comment area.

3. The document management apparatus according to claim 2,
wherein the handwriting operation unit is further configured to display the handwritten comment area or a list of handwritten comment areas on the display device and display the content of the handwritten comment area or content of one handwritten comment area selected from the list of handwritten comments areas on the display device, and
wherein the list of handwritten comment areas comprises content of each handwritten comment area of the plurality of pages and the handwritten comment area comprises the content of the handwritten comment area for the at least one page.

4. The document management apparatus according to claim 2,
wherein the data management unit is further configured to store, in the storage device, handwriting attribute data including position information indicating a position within the page with the handwritten comment area in association with the document image data or the handwritten data, and
wherein the handwriting operation unit is further configured to display, on the display device, a reduced image of the page with the handwritten comment area and an image illustrating the position of the handwritten comment area within the reduced image and the content of the handwritten comment area.

5. The document management apparatus according to claim 1, wherein the handwriting operation unit is further configured to:
determine, for at least one user, whether or not editing content of the handwritten comment area is forbidden; and
when editing the content of the handwritten comment is forbidden, forbid the at least one user from editing the content of the handwritten comment area.

6. The document management apparatus according to claim 1, further comprising:
a character recognition unit configured to convert a handwritten character in the handwritten comment area to text data,
wherein the handwritten data includes the text data converted from the character recognition unit.

7. The document management apparatus according to claim 1, further comprising:
a communication processing unit,
wherein the handwriting operation unit is further configured to transmit the handwritten data, to a specified address using the communication processing unit.

8. The document management apparatus according to claim 1, wherein the handwriting operation unit is further configured to, upon receipt of the operation for editing the content of the handwritten comment area, store additional data that defines the editing in association with the handwritten data.

9. A non-transitory computer-readable recording medium storing a document management program executable by a computer of a document management apparatus, the document management program comprising:
first program code for causing the computer to extract a handwritten comment area within a document image,
second program code for causing the computer to store, in a storage device, document image data indicative of the document image and, in association therewith, handwritten data that defines content of the handwritten comment area within the document image, and
third program code for causing the computer to update, upon receipt of an operation for editing content of the handwritten comment area, the handwritten data in accordance with the operation for editing.

10. The non-transitory computer-readable recording medium according to claim 9,
wherein the document image data includes image data indicative of at least one page of the document image or a plurality of pages of the document image,
wherein the second program code for further causing the computer to store, in the storage device, handwriting attribute data including identification information indicative of a page with the handwritten comment area in association with the document image data or the handwritten data, and
wherein the third program code for further causing the computer to display, on a display device, the identification information indicative of the page with the handwritten comment area and the content of the handwritten comment area.

11. The non-transitory computer-readable recording medium according to claim 10,
wherein the third program code for further causing the computer to display the handwritten comment area or a list of handwritten comment areas on the display device and display the content of the handwritten comment area or content of one handwritten comment area selected from the list of handwritten comments areas on the display device, and
wherein the list of handwritten comment areas comprises content of each handwritten comment area of the plurality of pages and the handwritten comment area comprises the content of the handwritten comment area for the at least one page.

12. The non-transitory computer-readable recording medium according to claim 10,
wherein the second program code for further causing the computer to store, in the storage device, handwriting attribute data including position information indicating a position within the page with the handwritten comment area in association with the document image data or the handwritten data, and
wherein the third program code for further causing the computer to display, on the display device, a reduced image of the page with the handwritten comment area and an image illustrating the position of the handwritten comment area within the reduced image and the content of the handwritten comment area.

13. The non-transitory computer-readable recording medium according to claim 9, wherein the third program code for further causing the computer to:
determine, for at least one user, whether or not editing content of the handwritten comment area is forbidden; and
when editing the content of the handwritten comment is forbidden, forbid the at least one user from editing the content of the handwritten comment area.

14. The non-transitory computer-readable recording medium according to claim 9, further comprising:
fourth program code for causing the computer to convert a handwritten character in the handwritten comment area to text data,
wherein the handwritten data includes the text data converted from the character recognition unit.

15. A method of document management comprising:
extracting, using a handwriting extracting unit, a handwritten comment area within a document image;
storing in a storage device, using a data management unit, document image data indicative of the document image and, in association therewith, handwritten data that defines content of the handwritten comment area within the document image; and
upon receipt of an operation for editing content of the handwritten comment area, updating, using a handwriting operation unit, the handwritten data in accordance with the operation for editing.

16. The method according to claim 15,
wherein the document image data includes image data indicative of at least one page of the document image or a plurality of pages of the document image,
wherein the data management unit is further configured to store, in the storage device, handwriting attribute data including identification information indicative of a page with the handwritten comment area in association with the document image data or the handwritten data, and
wherein the handwriting operation unit is further configured to display, on a display device, the identification information indicative of the page with the handwritten comment area and the content of the handwritten comment area.

17. The method according to claim 16,
wherein the handwriting operation unit is further configured to display the handwritten comment area or a list of handwritten comment areas on the display device and display the content of the handwritten comment area or content of one handwritten comment area selected from the list of handwritten comments areas on the display device, and
wherein the list of handwritten comment areas comprises content of each handwritten comment area of the plurality of pages and the handwritten comment area comprises the content of the handwritten comment area for the at least one page.

18. The method according to claim 16,
wherein the data management unit is further configured to store, in the storage device, handwriting attribute data including position information indicating a position within the page with the handwritten comment area in association with the document image data or the handwritten data, and
wherein the handwriting operation unit is further configured to display, on the display device, a reduced image of the page with the handwritten comment area and an image illustrating the position of the handwritten comment area within the reduced image and the content of the handwritten comment area.

19. The method according to claim 15, wherein the handwriting operation unit is further configured to:
determine, for at least one user, whether or not editing content of the handwritten comment area is forbidden; and
when editing the content of the handwritten comment is forbidden, forbid the at least one user from editing the content of the handwritten comment area.

20. The method according to claim 15, further comprising:
a character recognition unit configured to convert a handwritten character in the handwritten comment area to text data,
wherein the handwritten data includes the text data converted from the character recognition unit.
